(19) United States
(12) Patent Application Publication
(10) Pub. No.: US 2025/0353760 A1
(43) Pub. Date: Nov. 20, 2025

(54) METHOD OF REDUCING ENVIRONMENTAL METHYLMERCURY AND LIMITING ITS UPTAKE INTO PLANTS AND ORGANISMS

(71) Applicant: ALBEMARLE CORPORATION, Charlotte, NC (US)

(72) Inventors: Kim Sehye PINGREE, Baton Rouge, LA (US); Qunhui ZHOU, Concord, CA (US); Jon E. MILLER, Baton Rouge, LA (US); Sascha J. WELZ, Phoenix, AZ (US)

(21) Appl. No.: 18/058,961

(22) PCT Filed: May 28, 2021
(86) PCT No.: PCT/US2021/034863

§ 371 Date: Nov. 28, 2022

Related U.S. Application Data
(60) Provisional application No. 63/031,174, filed on May 28, 2020.

(51) Int. Cl. C02F 1/28; B01J 20/02; B01J 20/20; B01J 20/30; B01J 20/32; B09C 1/08; C02F 1/76; C02F 101/30; C02F 103/00

(52) U.S. Cl. CPC C02F 1/288; B01J 20/027; B01J 20/20; B01J 20/3085; B01J 20/3204; B01J 20/3234; B09C 1/08; C02F 1/766; C02F 1/283; C02F 2101/30; C02F 2103/007

(57) ABSTRACT

The disclosure relates to methods and processes for protecting food supply, organisms including fish and aquatic life, and plants from mercury accumulation by reducing the presence of methyl mercury in ecosystems, sediment, and pore water. The disclosure including treating sediment and/or pore water with an amendment that contains a sorbent and a halogen source, or a halogen containing sorbent.

### CROSS-REFERENCE TO RELATED APPLICATIONS

This application, filed May 28, 2021, under 35 U.S.C. § 119(e), claims the benefit of U.S. Provisional Patent Application Ser. No. 63/031,174, filed May 28, 2020, entitled “METHOD OF REDUCING ENVIRONMENTAL METHYL MERCURY AND LIMITING ITS UPTAKE INTO PLANTS AND ORGANISMS,” the entire contents and substance of which are hereby incorporated by reference as if fully set forth below.

### TECHNICAL FIELD

The various embodiments of the disclosure relate generally to methods of reducing methylmercury in environmental systems. It is particularly useful for limiting or preventing methylmercury uptake by aquatic and marine organisms, and plants.

### BACKGROUND

Many pollutants are known be toxic to humans and to the environment. One of these known environmental pollutants, mercury, has been categorized as one of the priority hazardous substances by the Agency for Toxic Substances and Disease Registry (the “ATSDR”). The US National Priorities List (NPL) has listed numerous sites that were contaminated by mercury, such sites comprising various substances, including solids (e.g., soil, debris, waste, and other solids), liquids (e.g., groundwater, lakes, ponds, and other liquids), and combinations of solids and liquids (e.g., sludge, slurries, sediments, and other combinations of solids and liquids). The majority of these sites have not been de-contaminated to remove mercury.

Moreover, environmental contamination by mercury compounds especially in soil and sediment can lead to the generation of methylmercury. The methylmercury is produced in the environment mainly by microbial methylation of the mercury pollutant. Methylmercury can be bioaccumulated and biomagnified in the aquatic food web, reaching its apex in predatory fish, where concentrations may be up to one million times higher than in the water column. As a result, even small concentrations of Hg in the water column (ng/L) can lead to significant concentrations of methylmercury in fish and waterfowl. Rice pads and other food chains may be similarly impacted by uptake of methylmercury. These items can ultimately reach the food sources for human consumption.

Identifying adjuvants and amendments that reduce or eliminate methylmercury in these systems is an ongoing effort in remediation. While many techniques focus on preventing ionic mercury, methods and strategies that access and remediate or prevent previous contamination of methylmercury, especially in sediment and pore water, is an ongoing challenge.

### BRIEF SUMMARY

The various embodiments of the disclosure relate generally to methods of protecting biota and ecosystems by removing methylmercury from pore water and other areas within the ecosystem processes, apparatus, devices, and systems for removing environmental pollutants from a mobile media, mobile phase, or mobile flow.

An embodiment of the disclosure can be a method of protecting aquatic, marine, and/or swamp organisms from mercury toxicity, comprising identifying a sample in the aquatic, marine and/or swamp ecosystem, treating the sample with an amendment, the amendment comprising a sorbent and a halogen source, and/or a halogenated sorbent, and reducing the amount and/or production of methylmercury in the sample, where the content of methylmercury in a pore water in the ecosystem is reduced by at least 60 percent.

Another embodiment of the disclosure can be a method of protecting a crop from mercury contamination, comprising identifying a soil sample into which a crop will be planted, treating the sample with an amendment, the amendment comprising a sorbent and a halogen source, and/or a halogenated sorbent, and reducing the amount and/or production of methylmercury in the sample, where the content of methylmercury in a pore water of the soil sample is reduced by at least 60 percent.

Another embodiment of the disclosure can be a method for removing methylmercury from a soil pore water, comprising treating a sediment samples that contains the pore water with an amendment, the amendment comprising a sorbent and a halogen containing compound, and/or a halogenated sorbent, and reducing the amount and/or production of methylmercury in the sample, where the content of methylmercury in the pore water is reduced by at least 60 percent.

In an embodiment of the disclosure, the content of methylmercury in the pore water can be reduced by at least 70 percent, or by at least 80 percent, or by at least 90 percent.

In an embodiment of the disclosure, the amendment is a carbonaceous material or an inorganic material. The amendment can be an inorganic material. The amendment can be a carbonaceous material.

In an embodiment of the disclosure, the amendment can be a halogen-containing sorbent, a bromine-containing sorbent, or a bromine-containing activated carbon.

In an embodiment of the disclosure, the halogen source can be a bromine source. The halogen source is a metal bromide salt or hydrobromic acid.

In an embodiment of the disclosure, the amendment can be Br-PAC, NaBr-PAC, or HBr-PAC, or combinations thereof.

### BRIEF DESCRIPTION OF THE DRAWINGS

FIGS. 1A and 1 B illustrate the experimental setup for the screening level toxicity tests, in accordance with an exemplary embodiment of the disclosure.

FIG. 2 illustrates the methylmercury reduction in porewater, in accordance with an exemplary embodiment of the disclosure.

FIGS. 3A and 3 B illustrate reduction of methylmercury accumulation in worm tissue, in accordance with an exemplary embodiment of the disclosure.

### DETAILED DESCRIPTION

Although preferred embodiments of the disclosure are explained in detail, it is to be understood that other embodiments are contemplated. Accordingly, it is not intended that the disclosure is limited in its scope to the details of construction and arrangement of components set forth in the following description or illustrated in the drawings. The disclosure is capable of other embodiments and of being practiced or carried out in various ways. Also, in describing the preferred embodiments, specific terminology will be resorted to for the sake of clarity.

It must also be noted that, as used in the specification and the appended claims, the singular forms “a,” “an” and “the” include plural referents unless the context clearly dictates otherwise.

Also, in describing the preferred embodiments, terminology will be resorted to for the sake of clarity. It is intended that each term contemplates its broadest meaning as understood by those skilled in the art and includes all technical equivalents which operate in a similar manner to accomplish a similar purpose.

Ranges can be expressed herein as from “about” or “approximately” one particular value and/or to “about” or “approximately” another particular value. When such a range is expressed, another embodiment includes from the one particular value and/or to the other particular value.

By “comprising” or “comprising” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

As used throughout this document, terms such as “treated”, “contacted”, and “remediated” indicate that amendment interacts with the substance containing methylmercury or other mercury source—the methylmercury or other mercury sources being present either before or after the amendment is used—in a manner that results in the reduction of environmental availability of methylmercury or other mercury source.

Methylmercury can be generated in sediment, and often resides in the pore water of the sediment rather than being more mobile like inorganic mercury species. Thus, traditional flow barriers, reactive caps, and similar permeable systems may be inefficient at removing methyl mercury trapped within the sediment or pore water. In particular, sequestration of the methylmercury within the sediment and the pore water can be challenging compared to ionic forms of mercury. However, microorganisms reside in that sediment and pore water, and plant life can grow in that sediment and pore water, and in the ecosystems in contact with the sediment and pore water, and can take up the methylmercury, thereby moving it through the food chain. The disclosure describes processes for reducing methyl mercury from sediment, soil and pore water, protecting environmental organisms, and preventing uptake of methylmercury into the food chain.

The objective of any amendment that remediates a pollutant like methylmercury should be to achieve at least two goals. First, the amendment should trap, eliminate or otherwise reduce the methylmercury from the sample, such that the organism or lifeform cannot absorb it, or at least leads to a substantial reduction in its uptake. Second, the amendment itself should be non-toxic. In particular, if the amendment will be left within the sample, the organisms or lifeforms should not be impacted by treatment with the amendment.

A process disclosed in PCT/US2019/030729 included a halogenated sorbent that we have continued to develop. In testing the application of that disclosure and other compositions to environmental challenges, we have discovered that not only does it competitively adsorb pollutants, but it can achieve the two-fold objective of eliminating methylmercury from pore water and is non-toxic to organisms. As described in the Examples, the amount of methylmercury, generated biologically by the sample, can be substantially reduced in sediment, and especially in the pore water of the sediment. Moreover, marine organisms growing in a sample polluted by methylmercury prior to treatment continue to live, grow and multiply within that sample.

The disclosure can then include a method for removing methylmercury from a soil sample, sediment and/or a pore water. Soil sample or sediment can contain a pore water having mercury within it and can be treated with an amendment, where the amendment can include a sorbent and a halogen containing compound, and/or a halogenated sorbent.

The disclosure can also include a method of protecting aquatic, marine and/or swamp organisms from mercury toxicity. A sample can be identified in an aquatic, marine and/or swamp ecosystem that contains the organism and pore water in it. The sample can be treated with an amendment, where the amendment can include a sorbent and a halogen containing compound, and/or a halogenated sorbent, and thus can reduce the amount and/or production of methylmercury in the sample. The term ecosystem can be biological community of interacting organisms and their physical environment, including adjacent areas that have water that can run off into the aquatic, marine, or swamp. By reducing, removing and/or remediating a methylmercury from the ecosystem, lower level organisms such as worms can be protected from the pollutant, and thus methylmercury can be reduced or eliminated from the food chain.

The disclosure can also include a method of protecting a crop from mercury contamination. A soil sample can be identified into which a crop will be planted, and having a pore water, and the sample can be treated with an amendment, where the amendment can include a sorbent and a halogen containing compound, and/or a halogenated sorbent. Similarly to the reduction of methylmercury exposure for organisms in marine or aquatic environments, methylmercury can enter the food chain via plant growth in mercury-contaminated areas. (See, e.g. Li, R., Wu, H., Ding, J. et al. Mercury pollution in vegetables, grains and soils from areas surrounding coal-fired power plants. Sci Rep 7, 46545 (2017).)

The content of methylmercury in the pore water can be reduced according to this disclosure. The amount of reduction can be at least about 50 percent of an initially tested amount. The amount of reduction can be at least about 60 percent, at least 70 percent, at least about 80 percent, or at least about 90 percent. The sediment can be treated with an effective amount of the amendment in order to reduce the methylmercury in the pore water by at least about 50, 60, 70, 80, or 90 percent.

The disclosure can include a method where the aquatic, marine and/or swamp organism is protected by the treatment. The disclosure can include a survival rate for at least one measured organism, wherein the survival rates is at least about 75 percent, preferably at least about 100 percent. Survival rate here means total number of an organism within the sample compared to a sample with no amendment. The survival rate can also be higher because the organism can reproduce. Thus, the survival rate can be at least about 110 percent, at least about 125 percent or at least about 150 percent

The disclosure uses an amendment to reduce or eliminate the methylmercury in the sample. The amendment can be a sorbent. Preferably the amendment can be a sorbent in combination with a halogen source, where in combination with a halogen can include halogen-containing sorbents and/or sorbents used in combination with an external halogen source added with the sorbent to the sample. More preferably, the amendment is a halogen-containing sorbent.

The sorbent materials applied herein can include carbonaceous materials and inorganic materials. Suitable carbonaceous materials include, for example, without limitation, activated carbon, carbon black, char, and coke. A preferred carbonaceous material is activated carbon, which can be used in many forms including, for example, without limitation, powdered, granular, or extruded; and high specific surface area. Powdered activated carbon is a particularly preferred form of activated carbon.

Suitable inorganic materials include inorganic oxides such as alumina (amorphous and crystalline), silica, magnesia, zirconia and titania; natural zeolites, such as chabazite, clinoptilolite, and faujasite: synthetic zeolites, such as synthetic chabazite, zeolites with high Si:Al ratios (ZSM-5, beta zeolites, sodalite), zeolites with moderate to low Si:Al ratios (Y zeolites, A zeolites), silica alumina phosphate (SAPO) zeolite or zeotype, ion exchanged zeolites, uncalcined zeolites, clay minerals such as kaolin/kaolinite, bentonite, and montmorillonite; inorganic hydroxides and oxyhydroxides such as iron hydroxide and iron oxide hydroxide; mixed metal oxides and layered double hydroxides, such as hydrotalcites and metallated double layered clays; diatomaceous earth; cement dust; hydroprocessing catalysts including those on substrates such as alumina, silica, or titania; CaCO₃; and combinations of any two or more of the foregoing. Preferred inorganic materials include inorganic oxides, especially silica, natural zeolites, especially chabazite, and clay minerals, especially kaolinite and bentonite; CaCO₃ is also a preferred substrate material.

The halogen element in the halogen-containing sorbent or in the halogen source can be fluorine, chlorine, bromine, iodine, or a mixture of any two or more halogens. Bromine is a preferred halogen. Suitable halogen-containing compounds include, for example, without limitation, elemental iodine and/or iodine compounds, elemental bromine and/or bromine compounds, elemental chlorine and/or chlorine compounds, elemental fluorine and/or fluorine compounds, and other suitable halogen compounds, as will be known to those skilled in the art. Types of halogen-containing compounds that can be used include hydrohalic acids, alkali metal halides, alkaline earth metal halides, and ammonium halides.

Hydrohalic acids include hydrogen chloride, hydrogen bromide, and hydrogen iodide. Alkali metal halides include sodium fluoride, sodium chloride, sodium bromide, sodium iodide, potassium fluoride, potassium chloride, potassium bromide, and potassium iodide. Alkaline earth halides include magnesium chloride, magnesium bromide, calcium chloride, and calcium bromide. Ammonium halides include ammonium chloride, ammonium bromide, and ammonium iodide.

Preferred halogen-containing compounds include elemental bromine, hydrogen bromide, sodium chloride, sodium bromide, potassium iodide, and calcium bromide. Bromine-containing compounds are preferred halogen-containing compounds; more preferred are hydrogen bromide and elemental bromine, especially elemental bromine.

Halogen-containing sorbents can be made from the material and halogen-containing compounds as described in U.S. Pat. Nos. 6,953,494 and 9,101,907, and in International Patent Pub. No. WO 2012/071206. In some embodiments, preferred halogen-containing sorbents are bromine-containing sorbents. In some embodiments, preferred halogen-containing sorbents are halogen-containing activated carbons. In other embodiments, preferred halogen-containing activated carbons are chlorine-containing activated carbons, bromine-containing activated carbons, and iodine-containing activated carbons. In preferred embodiments, the halogen-containing sorbents are chlorine-containing activated carbons and bromine-containing activated carbons. In more preferred embodiments, the halogen-containing sorbents are bromine-containing activated carbons.

In some embodiments, the sorbent and a halogen containing compound, and/or a halogenated sorbent can Br-PAC (brominated PAC), NaBr-PAC (sodium bromide impregnated PAC), or HBr-PAC (hydrogen bromide impregnated PAC). HBr-PAC and NaBr-PAC are impregnated powdered activated carbon materials, where an aqueous solution of NaBr and/or HBr and PAC are thoroughly mixed and then heated to remove the excess water.

In other embodiments, preferred halogen-containing sorbents are chlorine-containing activated carbons and iodine-containing activated carbons. In still other embodiments, preferred halogen-containing sorbents are halogen-containing chabazites, halogen-containing bentonites, halogen-containing kaolinites, and halogen-containing silicas.

Halogen-containing sorbents, especially bromine-containing sorbents, more especially bromine-containing sorbents, can reduce environmental availability of pollutants in substances through means including, for example, without limitation, oxidation and/or adsorption. Adsorption can reduce the environmental availability of environmental pollutants by reducing mobility of such pollutants. Other ways in which halogen-containing sorbents can reduce environmental availability of pollutants are by enhancing the degradation of such pollutants through surface reactions; and/or by inhibiting the formation of pollutants such as methyl mercury; and/or by other mechanisms. In the processes of this disclosure, whether applied to solids, or liquids, or combinations thereof, the environmental pollutants adsorbed by halogen-containing sorbents are stabilized such that desorption into the environment is substantially minimized.

Mercury and other environmental pollutants are adsorbed onto or removed by halogen-containing sorbents, especially bromine-containing activated carbon. Different halogen (especially bromine) species can be formed on a halogen-containing sorbent, especially bromine-containing sorbents, particularly bromine-containing activated carbon.

Some halogen-containing sorbents, particularly bromine-containing activated carbons, can physically and chemically adsorb mercury of different oxidation states including elemental mercury, oxidized mercury, and organic mercury. Mercury adsorbed on bromine-containing activated carbon is stable in a wide range of pH values, where “stable” means that the mercury does not separate from the sorbent in appreciable amounts after adsorption.

### EXAMPLES

### Example 1—Screening-Level Spiking and Toxicity Assessment

In order to evaluate the effectiveness of amendments at reducing the bioavailability of mercury, an initial study was conducted on the screening-level spiking and toxicity and assessment using the freshwater oligochaete Lumbriculus variegatus (commonly referred to as the Blackworm). The screening level assessment demonstrated that appropriate sediment spiking concentrations were identified prior to conducting the bioaccumulation tests. The study confirmed that spiking process produced a high enough methylmercury concentration in natural sediment to allow for sufficient resolution to assess effectiveness of amendments at reducing mercury bioavailability, while also not causing significant mortality to the test organisms, therefore we could analyze the bioaccumulation of tested organisms at the end of the 28-day experiment.

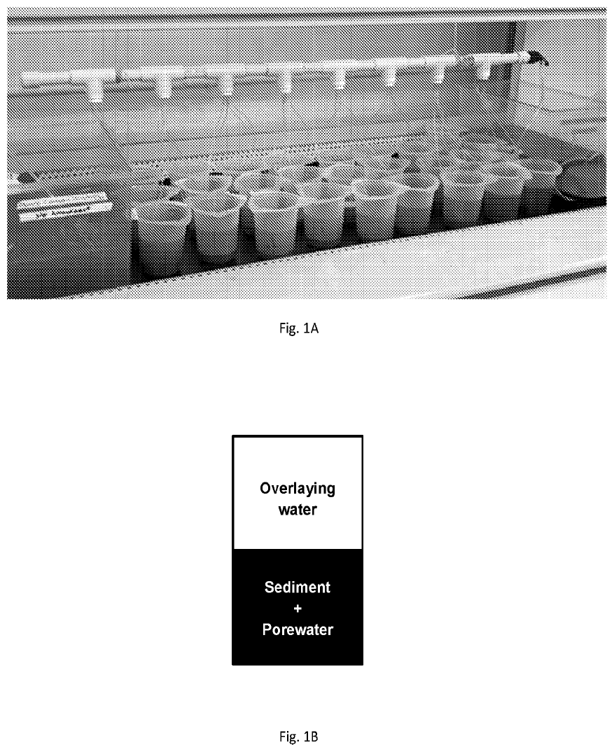

Natural sediment samples from a clean natural reservoir were collected, spiked with HgCl₂ at 200, 100, 20, and 0 mg/kg (unspiked) and stored under anoxic conditions for a 1-week period at room temperature to allow equilibration and natural processes including methylation to occur. Br-PAC was then added to the spiked sediment by thorough mixing and allowed to acclimate 24-hour before use. A 10-day exposure with the freshwater oligochaete (Lumbriculus variegatus) worm was conducted following standard guidance provided in EPA 600/R-99/064 (Methods for Measuring the Toxicity and Bioaccumulation of Sediment-associated Contaminants with Freshwater Invertebrates, Second Edition, 2000), and EPA 712-C-16-002 (Ecological Effects Test Guidelines OCSPP 850.1735: Spiked Whole Sediment 10-Day Toxicity Test, Freshwater Invertebrates, 2016). Ten worms (Lumbriculus) were added to 3 replicates for each treatment combination in addition to a primary and secondary control with clean sediment. (FIG. 1)

The survival results of treated sediment for Lumbriculus is shown in Table 1. Survival exceeded 100% in all treatments and the control indicating no toxicity due to the mercury or amendment at the concentrations tested. Survival exceeded 100% due to worm reproduction that occurred during the test.

Sediment and water chemistry analysis results indicate the successful production of methylmercury in all samples. In summary, the natural sediment selected for the study proved to be suitable Lumbriculus based on high survival in all treatments, and also effective at converting total mercury to methylmercury, particularly in pore water. Mercury spiking procedures were also effective resulting in total concentrations that were within 15% of the target in whole sediment.

TABLE 1
Survival of Lumbriculus on Day 10 of the Phase
I Bioaccumulation Study of Br-PAC treated Sediment

| HgCl₂ | | Survival Counts | | | | |
|---|---|---|---|---|---|---|
| (mg/kg DW) | | | Number | % | | % Effect |
| and Br-PAC | Rep- | Initial | Alive | Sur- | Mean % | to Lab |
| (%) Nominal | licate | Number | (10-d) | vival | Survival | Control |
| Lab Control | A | 10 | 20 | 200 | 233 | Baseline |
| 1 (Primary)^{a} | B | 10 | 22 | 220 | | |
| | C | 10 | 28 | 280 | | |
| Lab Control | A | 10 | 17 | 170 | 203 | 12.9 |
| 2 (Secondary) | B | 10 | 19 | 190 | | |
| | C | 10 | 25 | 250 | | |
| 20 mg/kg | A | 10 | 22 | 220 | 233 | 0.0 |
| DW 0.5% | B | 10 | 23 | 230 | | |
| Br-PAC | C | 10 | 25 | 250 | | |
| 100 mg/kg | A | 10 | 23 | 230 | 230 | 1.4 |
| DW & 0.75 | B | 10 | 20 | 200 | | |
| % Br-PAC | C | 10 | 26 | 260 | | |
| 100 mg/kg | A | 10 | 21 | 210 | 223 | 4.3 |
| DW & 1% | | | | | | |
| Br-PAC | | | | | | |

### Example 2—Methylmercury Reduction in Mercury Contaminated Sediment

Natural sediment samples from a clean natural reservoir were collected, spiked with HgCl₂ at 200, 100, 20, and 0 mg/kg (unspiked) and stored under anoxic conditions for a 1-week period at room temperature to allow equilibration and natural processes including methylation to occur. Br-PAC was then added to the spiked sediment by thorough mixing and allowed to acclimate 24-hour prior to analysis. Overlaying water from the reactor was removed from whole sediment first and porewater was further separated from whole sediment by filtration. Total mercury and methylmercury concentration of each fraction (sediment, porewater and overlaying water) that are treated with Br-PAC was analyzed in comparison of untreated sediment. See FIGS. 1A and 1B, showing the experimental setup for the screening level toxicity tests in 400 ml beakers and surrogate chambers in 12L containers for analytical chemistry.

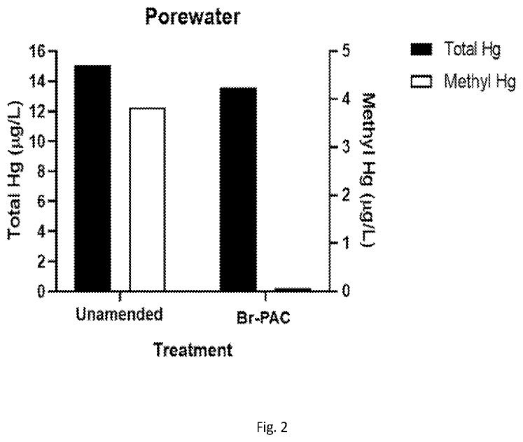

Methylmercury in both the overlying waters and whole sediment decreased by approximately 40% in the amended samples compared to those without the amendment. The concentration of methylmercury in the porewater for the unamended sample (3.83 μg/L) was greater than that in the overlying water (0.017 μg/L), however the concentration in the porewater with the amended sediment decreased more than 99% to a value of just 0.06 μg/L demonstrating the substantial effectiveness of the treatment at reducing methylmercury production. (FIG. 2.)

Another way to show the transformation of total mercury to methylmercury is to compare the fraction of methylmercury measured. The fraction of methylmercury reached 25.4% in the porewater of the untreated sediment compared to only 0.5% in Br-PAC treated sediment. (Table 2) The mechanism to explain these observations for the reduction of methylmercury has not been elucidated. However, the mechanism might not be able to simply be explained as adsorption process since methyl mercury as a Fraction of total mercury with and without Br-PAC in sediment/overlaying water/porewater are varied.

TABLE 2
Methylmercury as a Fraction of Total
Mercury with and Without Br-PAC

| | Total mercury | | Methylmercury | | | |
|---|---|---|---|---|---|---|
| | (THg) (μg/L) | | (MeHg) (μg/L) | | MeHg/THg (%) | |
| | | Br-PAC | | Br-PAC | | Br-PAC |
| | Control | treated | Control | treated | Control | treated |
| Sediment | 90.3 | 86.7 | 0.113 | 0.0643 | 0.13 | 0.07 |
| Overlaying | 3.36 | 6.76 | 0.0172 | 0.0107 | 0.51 | 0.16 |
| Water | | | | | | |
| Porewater | 15.1 | 13.6 | 3.83 | 0.0637 | 25.36 | 0.47 |

### Example 3—Reduction of Bioaccumulation in Freshwater Worm Lumbriculus variegatus

A 28-day bioaccumulation exposure experiment using Lumbriculus worms was conducted to demonstrate the effectiveness of Br-PAC at reducing the bioavailability of mercury, following standard guidance provided in EPA 600/R-99/064 (Methods for Measuring the Toxicity and Bioaccumulation of Sediment-associated Contaminants with Freshwater Invertebrates, Second Edition, 2000), and EPA 712-C-16-002 (Ecological Effects Test Guidelines OCSPP 850.1735; Spiked Whole Sediment 10-Day Toxicity Test, Freshwater Invertebrates, 2016). Exposure experiment was performed in 12-liter chambers with untreated and Br-PAC treated sediment spiked with mercury (100, 10, 1, and 0 mg/kg total Hg currently proposed). The methylmercury spiking procedure using natural sediment in order to achieve the high methylmercury concentration in sediment was described in Example 1. After spiking and the 4-week equilibration period, the amendment was added to the spiked sediment by thoroughly mixing and allowed to acclimate 24-hour before use. Tissues from all 5 test replicates in each treatment was measured for total mercury and lipid content, which could provide us information of bioaccumulation at the end of the 28-day exposure with and without amendment for analysis.

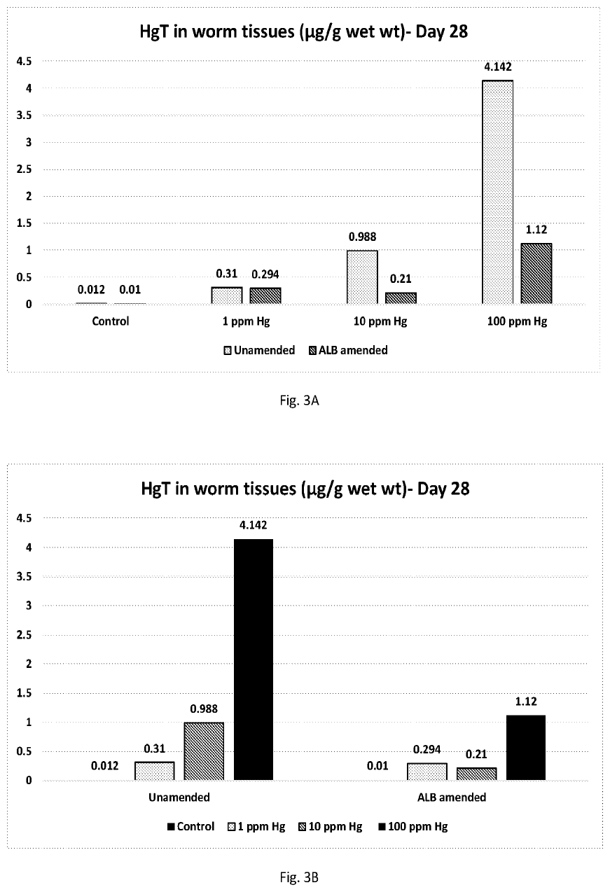

A summary of mercury and lipid concentrations in Lumbriculus worm tissues at 28 is summarized in FIGS. 3A and 3B. Live organisms predominantly accumulate the methylated form of mercury and it is assumed that the total mercury measurement in tissues is representative of methylmercury concentrations. Sediments amended with Br-PAC were successful at reducing bioavailability of mercury in worm tissues in all three spiked treatments. Wet weight concentrations of mercury ranged from 0.24 to 4.79 μg/g in unamended sediments and 0.19 to 1.62 μg/g in Br-PAC amended sediments among the three mercury spiked concentrations. Concentrations of mercury in the worm control tissues were low as expected ranging from 0.01 to 0.10 μg/g wet weight among all treatments and time periods. See FIGS. 3 A and B, showing methylmercury accumulation in worm tissues (μg/g wet wt) in the sediment samples that are treated with Br-PAC compared with untreated sediment at 4 mercury concentrations (0, 1, 10 and 100 ppm).

A summary of the treatment effectiveness of Br-PAC based on the ratio of mercury in unamended versus amended sediments is provide in Table 3. On Day 14 of the test worm tissues in the Br-PAC amended sediment had approximately 2.8 and 3.6 times less mercury in the 10 and 100 mg/kg Hg concentrations, respectively than that in the unamended sediments. Results were very similar at Day 28, where there was 4.7 and 3.7 times less mercury in the 10 and 100 mg/kg Hg concentrations, respectively than that in the unamended sediments.

TABLE 3
Treatment effectiveness at reducing bioaccumulation in Lumbriculus
- Mean concentration of Mercury in tissues in unamended and
Br-PAC amended Sediments The comparable values between Day
14 and Day 28 indicate a steady state equilibrium of mercury
content in the worm tissues within 2 weeks.

| | Sediment Mercury | |
|---|---|---|
| | Concentration | Difference Factor (X) |
| Day | (mg/kg) | (Unamended/Amended) |
| 14 | 1.0 | 1.27 |
| | 10 | 2.86 |
| | 100 | 3.59 |
| 28 | 1.0 | 1.06 |
| | 10 | 4.73 |
| | 100 | 3.77 |

### Example 4—Reduction of Bioaccumulation Measured by BSAF

Another way to analyze the bioaccumulation is Biota to sediment accumulation factor (BSAF), which provide a measure of bioavailability directly from the sediments to the tissues. Results are presented in Table 4 for total mercury and methylmercury in the sediment for each mercury spiked treatment at both Day 14 and Day 28. BSAF values calculated using total sediment mercury concentrations ranged from 0.01 on both Day 14 and Day 28 in the Br-PAC amended 100 mg/kg Hg treatment to 0.23 in the Br-PAC amended 1.0 mg/kg Hg treatment on Day 28. These results indicate that the total mercury concentrations were consistently much greater in the sediment than that in the worm tissues. Despite the limited accumulation of mercury in tissues relative to total mercury in the sediment, BSAF values were consistently lower for the Br-PAC treated sediments spiked with 10 and 100 mg/kg Hg. For total mercury, BSAF ratios between unamended and Br-PAC amended sediments ranged from 0.9× in the 1.0 mg/kg treatment indicating no difference to a mean of 5.1× in the 10.0 mg/kg Hg treatment.

BSAF values calculated using methylmercury concentrations in the Br-PAC amended sediment ranged from a mean of 0.75 (0.57-0.81, n=5) on Day 28 in the 10.0 mg/kg Hg treatment to 22.9 in the unamended 100 mg/kg Hg treatment on Day 28. BSAF values greater than 1.0 indicate that the methylmercury preferentially partitioned from the sediment into the worm tissues. Bioaccumulation of methylmercury in the worm tissues was substantially greater in the unamended sediment with BSAF ratios between unamended and amended sediments ranging from 1.6× in the 1.0 mg/kg Hg treatment on Day 14 to a mean of 24× in the 10.0 mg/kg treatment on Day 28. Effectiveness of the Br-PAC treatment based on both BSAF ratios and worm tissue concentrations increased with increased mercury spiked sediment concentrations. A notable increase in effectiveness of the Br-PAC treatment was observed over time with greater BSAF ratios between unamended and amended sediment on Day 28 compared to that observed on Day 14.

TABLE 4
Biota to sediment accumulation factor (BSAFs) for
methylmercury with and without Br-PAC amendment

| Sediment Mercury | |
|---|---|
| Concentration | BSAF (methylmercury) |

| Amendment | (mg/kg) | Day 14 | Day28 |
|---|---|---|---|
| Untreated | 1 | 5.4 | 12 |
| | 10 | 7.6 | 16.5* |
| | 100 | 17.4 | 22.9 |
| Br-PAC | 1 | 3.4 | 3.9 |
| treated | 10 | 1.3 | 0.8* |
| | 100 | 3 | 1.51 |

*Mean value of 5 replicates

### Example 5—Methylmercury Reduction using Brominated Amendments

Example 1 and 2 indicated a significant reduction of methylmercury when treating sediment with Br-PAC, and a significant reduction of methylmercury in pore water. This methylmercury study was designed to confirm the comparative advantage of Br-PAC to reduce the methylmercury. Testing setup and conditions will be similar to the Example 1. 5 different amendments including 4 different brominated activated carbons were screened with three replicates of each. Table 5 summarizes the methylmercury concentration of porewater in methylmercury contaminated sediment that are treated with amendments compared with untreated sediment. While Br-PAC was prepared by gas phase bromination process, NaBr-PAC and HBr-PAC were prepared via impregnated method. The following table clearly indicated that all 3 brominated activated carbon samples showed a significant reduction of methylmercury in porewater in comparison of non-brominated activated carbon.

TABLE 5
Methylmercury concentration of porewater in methylmercury
contaminated sediment that are treated with amendments
compared with untreated sediment.

| Amendment | Average MeHg (ng/L) |
|---|---|
| Unamended | 9.27 |
| PAC | 5.7 |
| Br-PAC (8 wt % Br) | 0.77 |
| NaBr-PAC (8 wt % Br) | 2.31 |
| HBr-PAC (8 wt % Br) | 0.41 |

### EMBODIMENTS

Additionally or alternately, the disclosure can include one or more of the following embodiments.

Embodiment 1. A method for removing methylmercury from a soil pore water, including the steps of treating a sediment samples that contains the pore water with an amendment and reducing the amount and/or production of methylmercury in the sample. The amendment can contain a sorbent and a halogen containing compound, and/or a halogenated sorbent. The method can reduce the content of methylmercury in the pore water is reduced by at least 60 percent.

Embodiment 2. A method of protecting aquatic, marine, and/or swamp organisms from mercury toxicity. The method can include identifying a sample in the aquatic, marine and/or swamp ecosystem, treating the sample with an amendment, and reducing the amount and/or production of methylmercury in the sample. The amendment can contain a sorbent and a halogen source, and/or a halogenated sorbent. The content of methylmercury in a pore water in the ecosystem can be reduced by at least 60 percent.

Embodiment 3. A method of protecting a crop from mercury contamination. The method can include identifying a soil sample into which a crop will be planted, treating the sample with an amendment, and reducing the amount and/or production of methylmercury in the sample. The amendment can contain a sorbent and a halogen source, and/or a halogenated sorbent. The content of methylmercury in a pore water of the soil sample can be reduced by at least 60 percent.

Embodiment 4. The methods of any of the previous embodiments, where the content of methylmercury in the pore water is reduced by at least 70 percent. The content of methylmercury in the pore water is reduced by at least 80 percent, or by at least 90 percent.

Embodiment 5. The methods of any of the previous embodiments, wherein the amendment is a carbonaceous material or an inorganic material, or is a carbonaceous material.

Embodiment 6. The methods of any of the previous embodiments, wherein the amendment is a halogen-containing sorbent.

Embodiment 7. The methods of any of the previous embodiments, where the amendment is a bromine-containing activated carbon.

Embodiment 8. The methods of any of the previous embodiments, where the halogen source is a bromine source. The halogen source can be a metal halide salt or hydrohalide salt. The halogen source can be a metal bromide salt or hydrobromic acid.

Embodiment 9. The methods of any of the previous embodiments, wherein the amendment is Br-PAC, NaBr-PAC, or HBr-PAC, or combinations thereof.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based can be readily utilized as a basis for the design of other structures, methods, and systems for carrying out the several purposes of the embodiments and claims presented in this application. It is important, therefore, that the claims be regarded as including such equivalent constructions.

We claim:

1. A method of protecting aquatic, marine, and/or swamp organisms from mercury toxicity, comprising
Identifying a sample in the aquatic, marine and/or swamp ecosystem,
treating the sample with an amendment, the amendment comprising a sorbent and a halogen source, and/or a halogenated sorbent, and
reducing the amount and/or production of methylmercury in the sample,
where the content of methylmercury in a pore water in the ecosystem is reduced by at least 60 percent.

2. The method of claim 1, wherein the content of methylmercury in the pore water is reduced by at least 70 percent.

3. The method of claim 1, wherein the content of methylmercury in the pore water is reduced by at least 80 percent.

4. The method according to any of the preceding claims, wherein the amendment is a carbonaceous material or an inorganic material.

5. The method according to any of claims 1-3, the preceding claims, wherein the amendment is a carbonaceous sorbent.

6. The method according to any of claims 1-3, wherein the amendment is a halogen-containing sorbent.

7. The method according to any of claims 1-3, wherein the amendment is a bromine-containing activated carbon.

8. The method according to any of claims 1-3, wherein the halogen source is a bromine source.

9. The method according to any of claims 1-3, wherein the halogen source is a metal bromide salt or hydrobromic acid.

10. A method of protecting a crop from mercury contamination, comprising
Identifying a soil sample into which a crop will be planted
treating the sample with an amendment, the amendment comprising a sorbent and a halogen source, and/or a halogenated sorbent, and
reducing the amount and/or production of methylmercury in the sample,
where the content of methylmercury in a pore water of the soil sample is reduced by at least 60 percent.

11. The method of claim 10, wherein the content of methylmercury in the pore water is reduced by at least 70 percent.

12. The method of claim 10, wherein the content of methylmercury in the pore water is reduced by at least 80 percent.

13. The method according to any of the claims 10-12, wherein the amendment is a carbonaceous material or an inorganic material.

14. The method according to any of the claims 10-12, wherein the amendment is a carbonaceous sorbent.

15. The method according to any of the claims 10-12, wherein the amendment is a halogen-containing sorbent.

16. The method according to any of the claims 10-12, wherein the amendment is a bromine-containing activated carbon.

17. The method according to any of the claims 10-12, wherein the halogen source is a bromine source.

18. The method according to any of the claims 10-12, wherein the halogen source is a metal bromide salt or hydrobromic acid

19. A method for removing methylmercury from a soil pore water, comprising
treating a sediment samples that contains the pore water with an amendment, the amendment comprising a sorbent and a halogen containing compound, and/or a halogenated sorbent, and
reducing the amount and/or production of methylmercury in the sample,
where the content of methylmercury in the pore water is reduced by at least 60 percent.

20. The method of claim 19, wherein the content of methylmercury in the pore water is reduced by at least 70 percent.

21. The method of claim 19, wherein the content of methylmercury in the pore water is reduced by at least 80 percent.

22. The method according to any of claims 19-21, wherein the amendment is a carbonaceous material or an inorganic material.

23. The method according to any of claims 19-21, wherein the amendment is a carbonaceous sorbent.

24. The method according to any of claims 19-21, wherein the amendment is a halogen-containing sorbent.

25. The method according to any of claims 19-21, wherein the amendment is a bromine-containing activated carbon.

26. The method according to any of claims 19-21, wherein the halogen source is a bromine source.

27. The method according to any of claims 19-21, wherein the halogen source is a metal bromide salt or hydrobromic acid.

28. The method of any of claim 1-3, 10-12, or 19-21, wherein the amendment is Br-PAC, NaBr-PAC, or HBr-PAC, or combinations thereof.
